(19) United States
(12) Patent Application Publication
(10) Pub. No.: US 2004/0207523 A1
(43) Pub. Date: Oct. 21, 2004

(54) Integrated campus monitoring and response system

(75) Inventors: Robert Craig Powell, Austin, TX (US); James M. Knox, Austin, TX (US)

Correspondence Address: ZAGORIN O'BRIEN & GRAHAM, L.L.P., 7600B N. CAPITAL OF TEXAS HWY., SUITE 350, AUSTIN, TX, 78731, US

(73) Assignee: SA Corporation, a Texas Corporation, Austin, TX

(21) Appl. No.: 10/418,788

(22) Filed: Apr. 18, 2003

(51) Int. Cl. G08B 1/08

(52) U.S. Cl. 340/539.13; 340/539.21; 340/573.1

(57) ABSTRACT

Individuals who carry personal transmitters in a particular area are remotely monitored so that such individuals may indicate an emergency. In the event of an emergency (or other event), the individual may activate his or her personal transmitter. The signal sent by the transmitter is then detected by an array of sensors. The sensors are capable of determining a signal strength of the signal from the personal transmitter. A computer console is coupled to the sensors to receive the signal strength indications. The computer console is capable of calculating a location (e.g., within an area of uncertainty around a point location) of the transmitter based on the received signal strengths determined by one or more of the sensors. Emergency services may then be contacted and dispatched automatically or depending on a set of expert rules or depending on user input. Any emergency situation may be constantly monitored so that multiple emergency locations may be indicated and even tracked as the locations of personal transmitters change in response to a dynamically developing emergency.

### CROSS-REFERENCE TO RELATED APPLICATION

This application is related to U.S. patent application Ser. No. ______ (Attorney Reference No. 078-0002) entitled “Remote Monitoring, Location and Notification Product and Method Therefor,” filed on the same day as the present application, naming Robert Craig Powell and James M. Knox as inventors, and which is hereby incorporated by reference in its entirety.

### BACKGROUND

1. Field of the Invention

The present invention relates to information processing, and systems and networks therefor, and, more particularly, to techniques for remote monitoring (e.g., of personal transmitters for safety and security).

2. Description of the Related Art

Security and emergency response are becoming ever more important concerns of government agencies, businesses and schools. Being able to quickly sound an alarm or otherwise provide notification of an emergency event is quickly becoming a priority for such entities. In an emergency situation, speed of response of emergency personnel to the correct location within a campus can be a life or death matter. But oftentimes conventional alarm systems fail to provide necessary or helpful information to emergency response personnel (e.g., a correct or sufficiently precise location to responding emergency personnel, type of emergency, etc.). Incorrect or insufficient information often causes increased delay in emergency response time, and perhaps even response by incorrect or insufficient personnel. This can, in turn, cause an increase in risk to potential victims, patients and even the emergency personnel themselves.

Accordingly, an effective means for locating and describing personnel, emergencies and/or other conditions within a remotely monitored area would be desirable to enhance the ability to respond to emergency events, among other advantages.

### SUMMARY

The present invention relates to information processing, and systems and networks therefor, and, more particularly, to techniques for remote monitoring (e.g., of personal transmitters for safety and security). In one embodiment, a remote monitoring system comprises an array of sensors coupled to a computer console. Each of the sensors is configured to receive a signal from one or more transmitters. Each sensor is further configured to determine a signal strength of the signal responsive to receiving the signal. The console is coupled to receive the signal strength from each sensor which receives the signal. The console is configured to process the signal strength and information indicative of each sensor receiving the signal to determine a location related to the transmitter.

In another embodiment, a method is provided to configure a system for remote monitoring. For example, a plurality of sensors may be configured for reception of a wireless signal from a transmitter. The sensors may also be configured to provide transmission information by each sensor responsive to receiving the wireless signal. The transmission information is defined to include at least two of a signal strength indication, transmitter identity information and sensor identity information. A computer system may be configured for receipt of the transmission information from each sensor which receives the wireless signal and to determine a location of the transmitter using the transmission information.

In another embodiment, a method is provided (e.g., in the context of a system including a computer system and a plurality of sensors with known locations coupled to the computer system) which includes receiving a wireless signal from a transmitter by one or more sensors and providing transmission information by each of the one or more sensors responsive to receiving the wireless signal by each of the one or more sensors. The transmission information includes at least two of a signal strength indication, transmitter identity information and sensor identity information. The method further includes the step of determining a location of the transmitter using the transmission information responsive to receipt of the transmission information from each sensor which receives the wireless signal. In a further embodiment, the method includes the steps of determining an initial signal strength indication indicative of noise signals when no transmitter is transmitting and compensating a measured signal strength indication of the wireless signal with the initial signal strength indication to generate the signal strength indication. In another further embodiment, the method may includes steps such as contacting emergency response personnel by the computer system responsive to receiving the transmission information and determining the location and/or providing location information regarding the location of the transmitter upon contacting the emergency response personnel (e.g., law enforcement personnel and medical service provider personnel).

In another embodiment, an apparatus includes a computer system and a number of sensors. Each sensor includes a means for receiving a wireless signal from a transmitter and a means for providing transmission information including at least two of a signal strength indication, transmitter identity information and sensor identity information. The computer system includes a means for determining a location of the transmitter using the transmission information.

The foregoing provides a brief description, or summary, of certain embodiments discussed in greater detail in the description below. Consequently, the foregoing contains, by necessity, simplifications, generalizations and omissions of detail. Consequently, those skilled in the art will appreciate that the foregoing summary is illustrative only and that it is not intended to be in any way limiting of the invention. Other aspects, inventive features, and advantages of the present invention, as defined solely by the claims, may be apparent from the description set forth below.

### BRIEF DESCRIPTION OF THE DRAWINGS

FIG. 1 is a block diagram showing an exemplary system/network for remote monitoring.

FIG. 2 is a block diagram showing an exemplary console of the network of FIG. 1.

FIG. 3 is a flowchart showing an exemplary operational flow of a remote monitor initialization thread.

FIG. 4 is a flowchart showing an exemplary operational flow of a poll receive timer thread for remote monitoring.

FIG. 5 is a flowchart showing an exemplary operational flow of an alarm parse module initiated by the poll receive timer thread of FIG. 4.

FIG. 6 is a flowchart showing an exemplary operational flow of a thread monitor initiated by the poll receive timer thread of FIG. 4.

FIG. 7 is a flowchart showing an exemplary operational flow of a transmitter thread initiated by thread monitor of FIG. 6.

FIG. 8 is a flowchart showing an exemplary operational flow of a location calculation timer thread initiated by the poll receive timer thread of FIG. 4.

### DETAILED DESCRIPTION

The following discussion is intended to provide a detailed description of at least one example of the invention and should not be taken to be limiting of the invention itself. Rather, any number of variations may fall within the scope of the invention which is properly defined in the claims following this description.

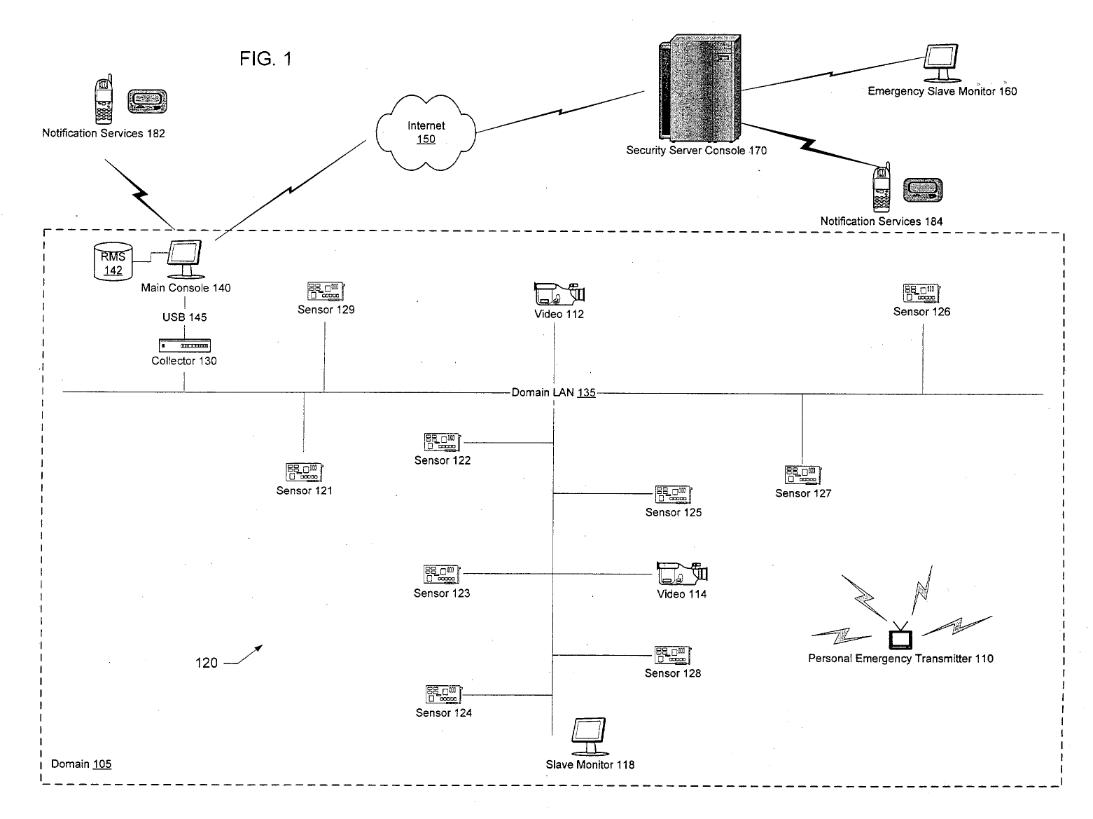

FIG. 1 is a block diagram showing an exemplary system/network for remote monitoring of a domain 105. In some examples provided herein, domain 105 is a school campus. However, domain 105 may be any type of campus, building, area, district, environment, or the like in which monitoring is desired. Accordingly, domain 105 may include one or more buildings and any intervening and/or surrounding grounds. For example, if domain 105 includes the grounds of a facility, domain 105 may be represented as a two-dimensional map of such grounds. Also for example, domain 105 may be represented in three dimensions (or a number of two-dimensional representations) when domain 105 includes one or more buildings or other structures with multiple floors or levels (including roof tops) located throughout an overall campus.

As shown, system 100 includes a transmitter 110, a monitor array 120 (which includes sensors 121-129 and video cameras 112 and 114), slave monitor 118, collector 130, main console 140, security server console 170, and emergency slave monitor 160, with appropriate couplings therebetween. Also shown are various communications devices 182, 184 which may be used to provide notification services. As is discussed below, the system is configured with a monitor array 120 for detecting signals from transmitters (e.g., transmitter 110) and for relaying signals to consoles such as consoles and monitors 140, 160, and/or 170 for monitoring by console software (e.g., remote monitoring software 142) and appropriate personnel.

Transmitter 110 can take the form of a personal transmitter which may be carried by designated personnel who work, reside or are otherwise present within or near domain 105. For example, in a school campus, all or a selected subgroup of teachers, administrators and/or other staff may carry transmitters for use in the event of an emergency. Certain staff, students, visitors or other parties who have a known medical condition may each be assigned a transmitter as necessary or desired. In one embodiment, the transmitter is a compact device which may be carried in a pocket or worn about the neck. Such an embodiment allows the transmitter to be carried throughout domain 105.

Transmitter 110 is a device which is capable of sending out one or more wireless signals (e.g., electromagnetic wave signals such as radio frequency (RF) signals) which are intended to be detectable by sensors in monitor array 120. Transmitter 110 may have a single button (e.g., an alarm button) to be depressed in the event of an emergency. Alternatively, the transmitter 110 may be programmed to transmit different signals with multiple button depressions, or may have more than one button, or may have other input mechanisms to indicate different types of emergencies or other information. Each transmitter is equipped with its own power source such as a standard direct current battery.

For simplicity of presentation, system 100 is illustrated as including one transmitter 110. However, as discussed, it is to be fully expected that multiple ones of such transmitters will often be used. When multiple transmitters are used, each transmitter may be configured to uniquely identify itself to system 100 as necessary. For example, transmitter 110 may identify itself by transmitting a unique code which identifies the person or the transmitter calling for help. In one embodiment, this unique code may be periodically altered (e.g., by using a rolling checksum) to prevent spoofing of the transmitter by unauthorized personnel. A unique ID may be used as a seed to generate a pseudo-random ID for use in identifying the transmitter. In one embodiment, a single radio frequency is used for all transmitters 110, but other embodiments may assign unique radio frequencies to each transmitter 110.

Also, the transmitters may be designed with a type of mutual avoidance and/or random back-off capability such that the two transmitters will not interfere with one another. For example, transmitters 110 in system 100 may be designed to transmit in a pseudo-random timing pattern so that if two transmitters have overlapping transmissions at a given time, the two transmitters will not continue to overlap at later times, thereby facilitating the tracking of both transmitters and all other transmitters in system 100.

Monitor array 120 includes sensors 121-129 for detecting transmissions from transmitters 110. Sensors 121-129 are located at various locations throughout domain 105. Various placement techniques may be used to locate sensors 121-129 within domain 105 to provide detection coverage for all locations within domain 105. For example, sensors 121-129 may be evenly spaced around or an appropriate distance inside the perimeter of domain 105, and at various points within domain 105. The number and placement of sensors may be uniform. Alternatively, a customized sensor location and population plan may be developed for each different area. Different types and sizes of areas will often require different numbers of sensors and different distances between sensors. For example, larger areas will require more sensors than smaller areas. Also, areas with features which cause interference or shielding or other effects may require a customized plan of sensor placement to take such interference into account. For example, some areas may have inherent electromagnetic noise interference from on-site equipment or from surrounding areas, or electromagnetic shielding as part of structures in the area. In such areas, a greater number of sensors, sensors placed more closely together, more robust antennae structures, or other means for ensuring signal detection may be required.

Sensors 121-129 are coupled via a domain local area network (LAN) 135 to collector 130. Any appropriate type of LAN may be used, and the LAN may be a special purpose, general purpose or a multipurpose LAN. LAN 135 may be wireless, but in the presently discussed embodiment LAN 135 is a non-wireless (i.e., line-based), dedicated wiring network (e.g., Cat5e cable). The wiring network of LAN 135 carries data packets to collector 130 for forwarding to main console 140 for analysis. In one embodiment, the wiring network 135 is coupled to provide battery backup power (e.g., low voltage DC power) to the sensors. For example, in one embodiment, up to 30 minutes, or even more, of backup power is provided in case of a failure of external AC power which may accompany an emergency.

Each sensor of monitor array 120 is configured to receive wireless (in this embodiment, RF) transmissions from transmitter 110. Accordingly, each sensor includes an antenna for receiving the transmission. Each sensor also includes a processor capable of processing the transmission and of forwarding certain information regarding the transmission to a collector/console. The antennae may be tuned to the characteristics of the space where they are installed or for the frequency which is to be used. In one embodiment, the transmitters transmit at approximately 315 MHz to facilitate a convenient antenna size with adequate wall penetration. In another embodiment, the transmitters use a spread spectrum transmission technique. One embodiment uses a double helical coil antenna for each sensor to diminish the effects of multi-path fading and to aid in-phase signal receipt while minimizing or eliminating the need for post receipt signal processing. In one embodiment, each sensor includes a super-heterodyne receiver with narrow pass band capabilities to eliminate noise. Also, transmitter ID's may be used to aid in tracking signals so that false signals caused by signal reflections can be canceled out or otherwise disregarded.

Each sensor is configured to provide information received from transmitter 110 or information locally derived regarding transmitter 110 to collector 130 via LAN 135. In one embodiment, each sensor determines a signal strength for each transmission received and communicates a received signal strength indication (RSSI) along with information identifying the transmitter to collector 130. In one embodiment, the sensor determines an initial RSSIₒ which is noise received when no transmitters are transmitting. The RSSIₒ can then be subtracted from the currently received signal strength to produce a transmitter RSSI and to aid in preventing false alarms when no transmitter 110 is in fact transmitting.

Other devices may be coupled to LAN 135. For example, one or more video cameras such as video cameras 112, 114 may be integrated within system 100 to provide remote video monitoring capability, a commonly desired feature. Also, one or more slave monitors such as slave monitor 118 may be coupled to LAN 135 for use in monitoring the status of the monitor array and/or to monitor video camera feeds from a location within or near domain 105 but remote from main console 140. In one embodiment, slave monitor 118 may receive emergency information from console 140 for display to the appropriate personnel.

Collector 130 is coupled to monitor array 120 via LAN 135 and to local console 140 via network coupling 145. Collector 130 collects data packets from sensors 121-129 and provides them to console 140 via network coupling 145 for subsequent analysis. Network coupling 145 may be an Ethernet connection, a Universal Serial Bus (USB) or other serial data connection, or any other appropriate network coupling type. In the presently discussed embodiment, a serial data connection is used. Other embodiments may use different apparatus to couple main console 140 to monitor array 120, and therefore may not require collector 130, among other possible variations.

Console 140 is a general purpose computer system which includes remote monitoring software (RMS) 142 stored in memory of console 140 (or otherwise accessible by or loadable to console 140). Upon execution, remote monitoring software 142 configures console 140 to perform certain calculations and other determinations regarding the information gathered by the monitor array 120 with a goal of locating transmitters within domain 105. Under control of remote monitoring software 142, console 140 compares the received signal strengths of signals received by sensors in monitor array 120, and computes the location of the emergency or signaled event. Console 140 is also configured to display the location and other information such as the name of the person needing assistance on a map of domain 105. Console 140 may also be configured to automatically initiate a call or message for assistance to appropriate emergency response personnel such as campus staff or security, a private security service, or a local public emergency rescue and/or law enforcement personnel. Such call for assistance may include the calculated location information.

For example, on a school campus, a teacher may see an emergency such as an injured student. The teacher can depress a button on the transmitter 110 carried by the teacher. The transmitter then transmits a radio frequency (RF) signal which may be detected by nearby sensors 125, 127 and 128, for example. Each of sensors 125, 127 and 128 calculates a signal strength of the signal received from transmitter 110, and sends the signal strength to console 140. Console 140 receives the various signal strength information from sensors 125, 127 and 128, identifies them as having come from the same transmitter 110, and calculates the location of the teacher based on the received signal strengths and the known locations of the sensors.

Triggering of emergency alarms in domain 105 may be monitored by on-site personnel in domain 105 or remotely by off-site personnel. Console 140 is coupled to remote monitor 160 and console 170 via Internet 150 to facilitate such off-site monitoring. In one embodiment, emergency slave monitor 160 is monitored by emergency response personnel (e.g., law enforcement and/or emergency medical service providers), and console 170 is monitored by a security service provider hired by the management personnel of campus 105.

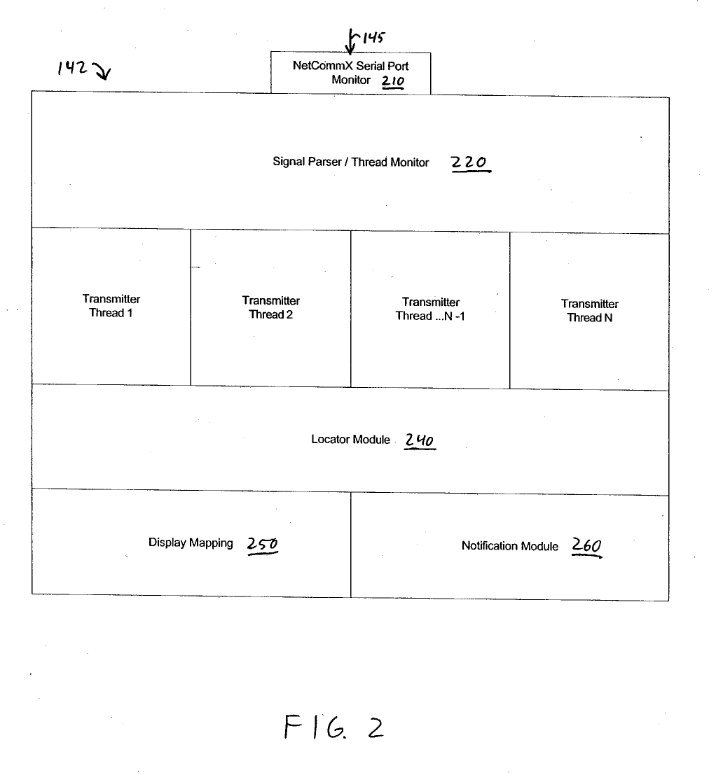

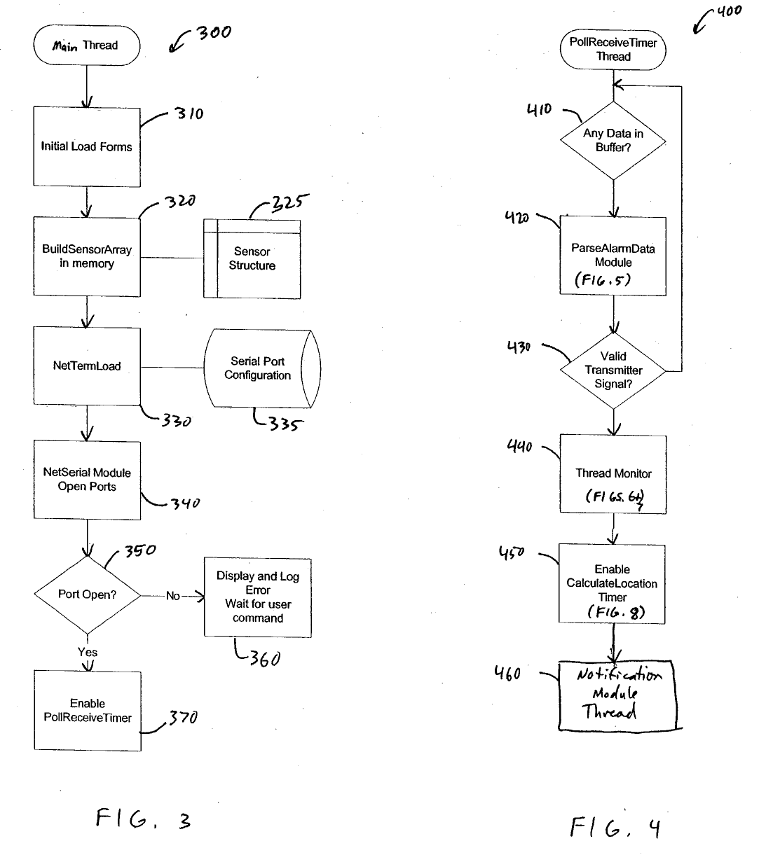

FIG. 2 is a block diagram showing local console 140 which includes serial port monitor 210 and remote monitoring software 142. Serial port monitor 210 is coupled to receive information from collector 130 of FIG. 1. Serial port monitor may be any of a variety of appropriate port monitors, and may vary depending on the type of network coupling 145. Remote monitoring software 142 includes a signal parser and thread monitor 220, display mapping module 250 and notification module 260. Signal parser and thread monitor receives information from the various sensors via serial port monitor 210 and generates various transmitter threads 1-N to process the information for each transmitter.

The remote monitoring software 142 initiates locator module 240 to determine the location of each transmission. That is, locator module 240 accesses the various transmitter threads 1-N and determines the location of a particular transmitter which is indicating an emergency. The locator module 240 determines the locations according to a process that uses the signal strengths of signals corresponding to the particular transmitter as discussed above. Display mapping module 250 then displays the location of the particular transmitter on a graphical user interface coupled to or integral with console 140. Depending on the configuration of remote monitoring software 142, notification module 160 then notifies the appropriate personnel as discussed above.

FIG. 3 is a flowchart showing an exemplary operational flow of remote monitoring software 142 represented as a main operational thread 300 which initializes subsequent children threads discussed below with reference to FIGS. 3-7. For example, main thread 300 initializes system 100 to prepare it for remote monitoring of transmitters 110, and initializes a poll receive timer which checks for incoming transmissions from transmitters and processes them accordingly.

Referring to FIG. 3, remote monitoring software 142 initializes local console 140 and prepares it to process information received from monitor array 120 by loading the necessary forms during initial load forms operation 310. After console 140 has loaded the necessary forms during operation 310, console 140 accesses a local database to generate a memory structure (e.g., sensor structure 325) for describing the monitor array 120 during build monitor array in memory operation 320. In the presently discussed embodiment, sensor structure 325 is stored in a main memory of local console 140.

After sensor structure 325 is initialized, local console 140 is configured to receive information from the monitor array 120. In the illustrated embodiment, a serial port configuration 335 is established for serial port monitor 210. After the serial port configuration 335 is established, the system is checked to determine if the necessary serial ports are open. If a serial port is determined to not be open during port open decision 350, information cannot be received by local console 140 from monitor array 120, and an error is generated, displayed and logged by serial port monitor 210 during error operation 360, whereafter local console 140 waits for user action. If the serial port is determined to be open during port open decision 350, information can be received by local console 140 from monitor array 120, and a poll receive timer thread 400 (discussed below with reference to FIG. 4) is enabled and a poll receive timer is initiated during enable poll timer operation 370.

FIG. 4 is a flowchart showing an exemplary operational flow of poll receive timer thread 400. Poll receive timer thread executes on console 140 and periodically polls the serial port to receive information regarding any transmissions within monitor array 120, and processes the transmissions accordingly, including buffering the information, determining the location of a transmitter indicating an emergency, displaying the location where applicable and notifying the proper authorities as necessary. Some or all of these functions may be performed by child threads spawned by the poll receive timer thread 400 to perform the function (or to in turn spawn additional threads to perform the function). As used herein, a parent thread may be credited with performing a function even if the actual function is directly performed by a child thread initiated by the parent thread to perform the function.

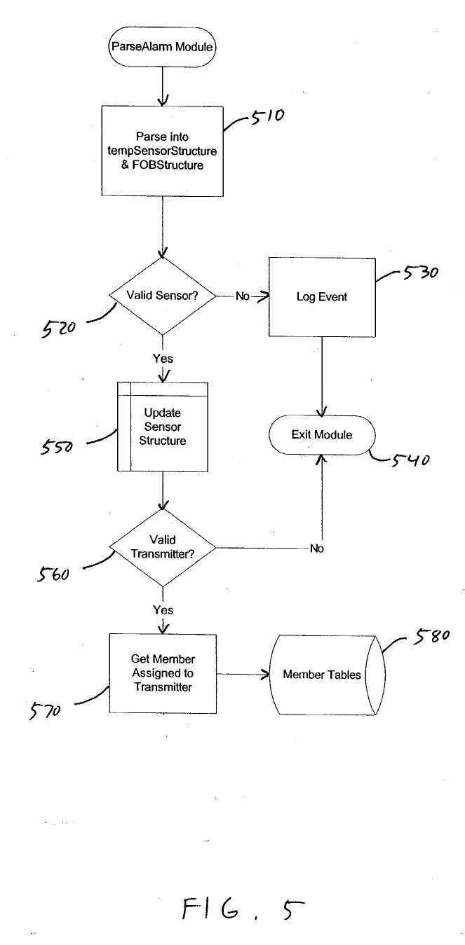

Poll receive timer thread 400 determines if there is any data in the buffer of serial port 210 during buffer check decision 410. If there is no data in the buffer of serial port 210, then no information has been received from any sensors about any transmissions from any transmitters, and poll receive timer thread 400 continues waiting for such information by continually polling the data buffer at buffer check decision 410. If there is data in the buffer of serial port 210, then information has been received from a sensor about a transmission from a transmitter, and control transitions to parse alarm data module 420. Parse alarm data module 420 parses the data from the serial port buffer into a data array and determines if the data is sent by a valid sensor and a valid transmitter. Parse alarm data module 420 is further discussed below with reference to FIG. 5.

FIG. 5 is a flowchart showing an exemplary operational flow of an alarm parsing module 500 of poll receive timer thread 400. During parse operation 510, the alarm data is parsed from the serial port buffer into a temporary sensor/transmitter structure to await verification of the alarm data. Once the alarm data is transferred from the serial port buffer, the parse alarm module 500 determines if the alarm data originates from a valid sensor during valid sensor decision 520. In one embodiment, a valid packet from a sensor will include packet information, a received signal strength indication (RSSI), a sensor ID and a transmitter ID. If the alarm data does not originate from a valid sensor, the error event is logged during log event operation 530, and the parse alarm module is exited at operation 540. If the alarm data originates from a valid sensor, sensor structure 325 is updated with information from the data packet during update operation 550.

After sensor structure 325 is updated, the parse alarm module 500 determines if the alarm data originates from a valid transmitter during valid transmitter decision 560. As discussed above, a unique transmitter ID may be used to identify the transmitter. The unique ID can be randomized in a preset fashion to prevent spoofing or mimicking of a legitimate transmitter signal by unauthorized personnel. Other methods of ensuring security of the transmitters may also be used. If the alarm data does not originate from a valid transmitter, the parse alarm module is exited at operation 540. If the alarm data originates from a valid transmitter, information is obtained regarding the transmitter. For example, information identifying a person to whom the transmitter was assigned is retrieved from member tables 580 during get member assigned to transmitter operation 570. If a series of invalid signals are detected to originate from a transmitter, a possible emergency or special notification may be generated to address a possible security breach scenario such as the system having being jammed or hacked.

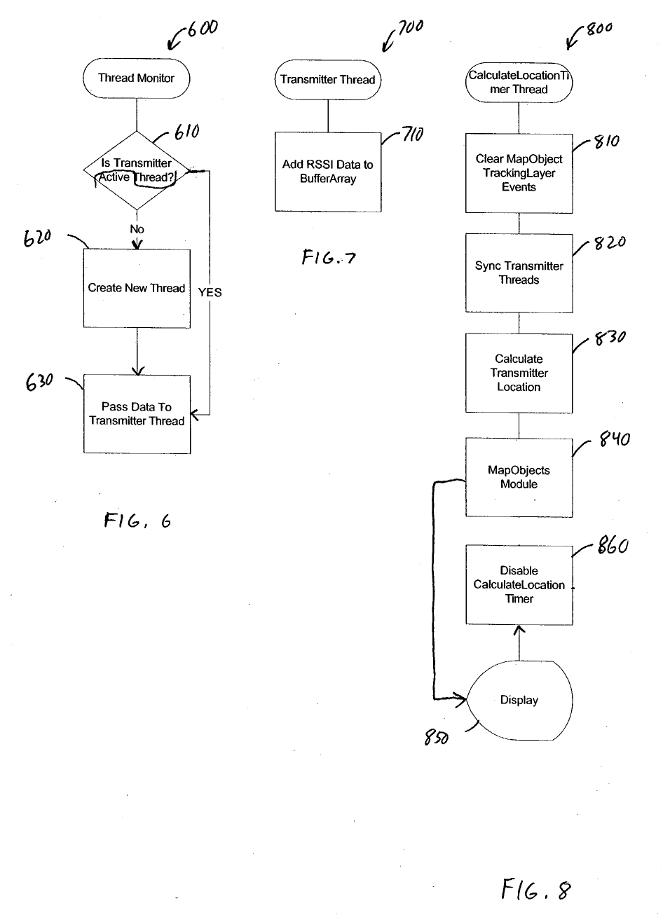

Referring again to FIG. 4, after the alarm data has been parsed by parse alarm data module 420, poll receive timer thread 400 determines if the information in the buffer corresponds to a valid transmitter signal during valid transmitter signal decision 430. If the parse alarm data module 420 determined that the information did not originate from a valid sensor or a valid transmitter, then poll receive timer thread continues waiting for further transmission information at check buffer decision 410. If the parse alarm data module determined that the information originated from a valid sensor and regarded a valid transmitter, poll receive timer thread 400 initiates thread monitor 440 which manages a number of threads (one for each transmitter) which process the alarm data. Thread monitor operation 440 is discussed in detail below with reference to FIGS. 6 and 7.

FIG. 6 is a flowchart showing an exemplary operational flow of a thread monitor initiated by the poll receive timer thread of FIG. 4. During transmitter thread active decision 610, thread monitor 600 determines if a transmitter thread is active for the particular transmitter sending the alarm data (e.g., as identified by the alarm data). A transmitter thread will be active if the transmitter has previously transmitted alarm data (e.g., if the bearer of the transmitter has previously pressed the alarm button on the transmitter). If a transmitter thread is not active for the transmitter during decision 610, a new thread is created for the transmitter during create new thread operation 620, after which the alarm data is passed from the temporary sensor/transmitter structure (referenced above with regard to operation 510) to the newly created transmitter thread during pass data operation 630. If a transmitter thread is active for the transmitter during decision 610, the alarm data is passed from the temporary sensor/transmitter structure to the active transmitter thread during pass data operation 630.

FIG. 7 is a flowchart showing an operation of a transmitter thread initiated by the thread monitor of FIG. 6. After N successive operations of thread monitor 600, transmitter threads 1-N (shown in FIG. 2) are executing in parallel on console 140. A different transmitter thread is initiated for each transmitter transmitting alarm data. As shown in FIG. 7, once the proper transmitter thread is either determined or created by thread monitor 600, the alarm data (e.g., received signal strength indication, or RSSI, data) is added to the buffer array for the particular transmitter thread. The buffer array is an array of received signal strength indications from sensors for a particular transmitter. During operation, the buffer array will store an RSSI array including information such as transmitter ID's identifying a transmitter corresponding to each transmission, sensor ID's identifying a sensor which detected each transmission, and RSSI's for each transmission detected by each sensor. Thus, each transmission from a transmitter may have multiple entries with different RSSI's for each sensor.

Referring again to FIG. 4, after the alarm data is assigned to a transmitter thread during thread monitor operation 440, a location for the transmitter is determined during enable calculate location timer operation 450. Calculate location timer operation 450 is described below with reference to FIG. 8 which provides a flowchart showing an exemplary operational flow of a calculate location timer thread 800 of the remote monitoring thread of FIG. 4. For each active transmitter thread 700, the calculate location timer thread 800 periodically calculates a transmitter location and maps the location for display on a graphical user interface of a console such as console 140, 160 and/or 170.

During clear events operation 810, map object tracking layer events are cleared from a map representation of domain 105. Prior tracked elements are cleared from the map representation for display. In one embodiment, the map representation is compatible with a geographic information systems (GIS) database representation. The GIS map representation is used even for the insides of buildings of domain 105. GIS representations are commonly used and accessible via the Internet. In such an embodiment, the transmitter location may be easily mapped into extended map representations beyond domain 105 when necessary and applicable, and the remote consoles can easily access and display such map representations. For example, if a teacher leaves domain 105 (e.g., goes off campus on a field trip), and a supplemental sensor network or other location means (e.g., global positioning system) is used to track the transmitter, the location information of the transmitter may be easily integrated within the present GIS system.

After clear events operation 810, transmitter threads are synchronized during sync transmitter threads operation 820. That is, the state of the transmitter thread is locked, and the information in each transmitter thread buffer is accessed for location calculations. Other information maybe received and buffered, but any information received after the transmitter thread state is locked will not be used in the current set of location calculations, but instead will be included in any subsequent location calculations (subject to a potential indication of information aging which can be used to cause old transmitter information to be removed from the transmitter thread buffer so that it is no longer considered for location calculations).

After the transmitter thread data is accessed during sync operation 820, a transmitter location is calculated during calculate transmitter location operation 830. Calculate location timer thread 800 calculates a location for each transmitter. In one embodiment, the last ten transmissions are used for each transmitter, with older transmission information being ignored as irrelevant to a present location.

As used herein, a determined location of a transmitter refers to an acceptable area of uncertainty which is centered around a point location. One example of an acceptable area of uncertainty is a circle with a radius of a few feet around an actual transmitter location, but the acceptable area of uncertainty may vary from context to context.

One embodiment uses a center of gravity calculation algorithm from the context of weight and balance calculations for aircraft bodies. This provides the advantage of not having to rely on a least squares curve fit. The method can even employ “phantom” sensor readings to facilitate handling of calculation difficulties introduced by using a finite monitor array.

Each sensor is at a known position defined relative to an axis with an arbitrary origin location. In one embodiment, the origin point of that axis is selected to be outside the area of non-zero RSSI readings to simplify calculations. A weighted value is assigned to the data from each sensor, where the weighting is equal to the distance of that sensor along each orthogonal axis (independently). For example, a sensor that is over two positions or reference distances to the right and up three positions from the origin has a weighting of Wx=3 and Wy=4. (This example is given in two dimensions, but it can be extended into a third dimension as necessary.) A “center of power” can now be calculated along the X-Y axis as:

$$Wx\_total = {\sum }_{i = 1}^{m} {\sum }_{j = 1}^{n} {Wx}_{i , j} * {RSSI}_{i , j}$$

$$Wy\_total = {\sum }_{i = 1}^{m} {\sum }_{j = 1}^{n} {Wy}_{i , j} * {RSSI}_{i , j}$$

$$Power\_total = {\sum }_{i = 1}^{m} {\sum }_{j = 1}^{n} {RSSI}_{i , j}$$

and finally . . .

Tx=Wx_total/Power-total

Ty=Wy_jotal/Power_total

where Tx and Ty are the estimated coordinates of the transmitter. The equations are representative of a graph of a three dimensional Gaussian curve over domain 105, where an apex of the curve is the estimated location of the transmitter. A third dimension can be added by simple extrapolation. A “Z” axis may be added, and the appropriate additional Z-axis calculation may be inserted. The equations would then represent a four dimensional graph of three spatial dimensions plus a density dimension.

The above calculations may be used regardless of exact sensor placement. The new sensor weightings will be functions of the coordinates and must be adjusted accordingly. Accordingly, even a highly non-symmetric sensor layout should provide similar results as long as the sensor layout is sufficient for transmission detection coverage.

Note also that infinite sensor coverage is not required. Although a transmitter theoretically radiates power to infinity, with rapidly decreasing power density. In practice, as soon as that power density drops below our noise floor (Nf) any further sensors are not going to contribute any meaningful data to the location calculations.

If only one sensor detects a transmission and generates an RSSI, the distance from a known sensor location can be calculated based on strength of signal received by the sensor. Knowing the loci of the sensor, the location of the transmitter can be determined as the surface of a sphere centered about the sensor antenna. The method may use two sensors to generate an indication of a more precise location near to and between the two sensors. If a second sensor detects the same transmission, a second sphere may be computed, which will likely intersect the first sphere. Since the intersection of two spheres is a circle, the transmitter has been located on the circumference of a circle of known center and radius. If a third sensor detects a transmission, the transmitter may be more precisely located. The intersection of a circle and a sphere is two points, occurring on opposite sides of the circle. If a fourth sensor detects a transmission, the location of the transmitter may be resolved as one of the two points. Additional sensor information can be used as an integrity check on the derived location, as well as helping to resolve real world measurement errors.

In one embodiment, the location calculations take into account the structures of domain 105 by using a rules-based analysis (e.g., as in expert systems). For example, if multiple signal strengths indicate a transmitter is on a fourth floor of a building in domain 105, and the next calculation indicates the transmitter is on the third floor, but the previous and new locations are not near a stairwell or other avenue of inter-floor movement, the remote monitoring software 142 may, under certain conditions, discard or tag the erroneous location indication in favor of an interpretation that the transmitter is merely on the floor of the fourth floor instead of being held in the air by someone on the third floor. Of course, at some point, the rules must accept without explanation a move into a room if a transmitter continues deeper into a room (e.g., clearly beyond an area of uncertainty that might include both rooms) even if there is no avenue for inter-room movement at that point.

Once a location is calculated for a given transmitter, the location is passed to a map objects module during map object operation 840. The map objects module maps the transmitter on a map representation of domain 105. Once the location is mapped in a map objects data structure, it may be displayed during display operation 850. Once the location of the transmitter has been displayed, the calculate location timer is disabled during timer disable operation 860 so that the calculate location timer thread is not continually running.

Referring again to FIG. 4, after a transmitter location is determined and displayed during calculate location operation 450, the proper authorities may be notified by a notification module thread during notification operation 460. Such notification may include sending a page, sending an email, making a telephone or cell phone call, sending a facsimile (fax), initiating an instant messaging contact, altering an electronic banner sign, sounding a klaxon or prerecorded alarm, or any other technique for sending a message, whether via the Internet, a wireless system, telecommunications lines, a public address system or otherwise.

The notification may include detailed information regarding the emergency or other event. For example, a floor plan may be transmitted to fire department or police authorities complete with emergency transmitter locations indicating the precise location of the emergency. The precise nature of the emergency may also be transmitted if the transmitter is enabled with input mechanisms for designating the type of emergency (e.g., extra buttons) or if a central operator adds such information to the system after making a such a determination. The type of emergency may also be inferred by the person to whom the transmitter was assigned. For example, if a student with a medical condition is assigned a transmitter, a central operator or the remote monitoring software itself can assume based on information in the member table database that an emergency particularly relevant to the student's condition is occurring. Also, updated information may be periodically, continuously or otherwise later transmitted to the proper response personnel if the location or nature of the emergency changes, such as in a violent confrontation in which hostages are being moved within a campus.

In one embodiment, a transmitter can be in an “always on” state or a periodically, automatically transmitting state to enable tracking throughout domain 105. For example, when a visitor visits a school campus, a visitor tag can be issued so that the visitor's location is always known. Also, valuable or important objects can be tracked using such tags. Also, some embodiments may employ a semi-random or periodic ability of transmitters and sensors to transmit non-emergency signals for system testing purposes.

In one embodiment, error detection information is transmitted by the transmitter with each wireless signal transmission. Errors can be detected using checksums or cyclic redundancy checks. Also, error correction information may be transmitted to correct for any errors detected. For example, forward error correction (FEC) data may be included in the overhead of each wireless signal. The FEC data includes redundant data which may be used to recover from errors such as missing or corrupted data.

The above description is intended to describe at least one embodiment of the invention. The above description is not intended to define the scope of the invention. Rather, the scope of the invention is defined in the claims below. Thus, other embodiments of the invention include other variations, modifications, additions, and/or improvements to the above description.

The foregoing components and devices are used herein as examples for sake of conceptual clarity. Consequently, as used herein these specific exemplars are intended to be representative of their more general classes. Furthermore, in general, the use of any specific exemplar herein is also intended to be representative of its class and the noninclusion of any specific devices in any exemplary lists herein should not be taken as indicating that limitation is desired. Moreover, alternative embodiments may combine multiple instances of a particular component (e.g., sensors, consoles, transmitters). Furthermore, it is to be understood that the architectures depicted herein are merely exemplary, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

Those skilled in the art will recognize that boundaries between the functionality of the above described steps and operations (see, e.g., FIGS. 3-8) are merely illustrative. The functionality of multiple steps may be combined into a single step, and/or the functionality of a single step may be distributed in additional steps. Moreover, alternative embodiments may include multiple instances of a particular step, and the order of steps may be altered in various other embodiments. In fact, the functionality of the steps is described in the context of threads which my operate at different times during the operation of console 140.

The steps discussed herein may consist of steps carried out by system users, hardware modules and/or software modules. Thus, the steps described herein may correspond to modules or portions of modules (e.g., software, firmware or hardware modules). For example, although the described embodiment includes software modules and/or includes manually entered user commands, the various exemplary modules may be application specific or general purpose hardware modules. The software modules discussed herein may include script, batch or other executable files, or combinations and/or portions of such files. The software modules may include a computer program or subroutines thereof encoded in computer-readable media. The functionality of operations referred to herein may correspond to the functionality of modules or portions of modules in various embodiments.

As discussed in relation to the steps of FIGS. 3-8 and the other operations described above, the boundaries between modules are merely illustrative and alternative embodiments may merge modules or impose an alternative decomposition of functionality of modules. For example, the modules discussed herein may be decomposed into submodules to be executed as multiple computer processes. Moreover, alternative embodiments may combine multiple instances of a particular module or submodule.

Each of the blocks/steps of FIGS. 3-8 may be executed by a module (e.g., a software module) or a portion of a module or a computer system user. Thus, the above described method, the operations thereof and modules therefor may be executed on a computer system configured to execute the operations of the method and/or may be executed from computer-readable media. The method may be embodied in a machine-readable and/or computer-readable medium for configuring a computer system to execute the method. Thus, the software modules may be stored within and/or transmitted to a computer system memory to configure the computer system to perform the functions of the module.

The software modules described herein may be received by system 100 or a console thereof, for example, from computer readable media. Such computer readable media may be permanently, removably or remotely coupled to computer system 100. Computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; volatile storage media including registers, buffers or caches, main memory, RAM, etc.; and data transmission media including computer networks, point-to-point telecommunication equipment, and carrier wave transmission media, just to name a few. Other new and various types of computer-readable media may be used to store and/or transmit the software modules discussed herein.

In one embodiment, console 140 is a computer system such as a personal computer system. Other embodiments may include different types of computer systems. Computer systems are information handling systems which can be designed to give independent computing power to one or more users. Computer systems may be found in many forms including but not limited to mainframes, minicomputers, servers, workstations, personal computers and embedded systems. A typical computer system includes at least one processing unit, associated memory and a number of input/output (I/O) devices.

A computer system processes information in steps according to a program and produces resultant output information via I/O devices. A program is a list of instructions such as a particular application program and/or an operating system. A computer program is typically stored internally on at least one computer readable storage medium or transmitted to the computer system via a computer readable transmission medium (e.g., a network). A computer process typically includes an executing (running) program or portion of a program, current program values and state information, and the resources used by the operating system to manage the execution of the process. A parent process may spawn other, child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process.

Because the above detailed description is exemplary, when “one embodiment” is described, it is an exemplary embodiment. Accordingly, the use of the word “one” in this context is not intended to indicate that one and only one embodiment may have a described feature. Rather, many other embodiments may, and often do, have the described feature of the exemplary “one embodiment.” Thus, as used above, when the invention is described in the context of one embodiment, that one embodiment is one of many possible embodiments of the invention.

Notwithstanding the above caveat regarding the use of the words “one embodiment” in the detailed description, it will be understood by those within the art that if a specific number of an introduced claim element is intended in the below claims, such an intent will be explicitly recited in the claim, and in the absence of such recitation no such limitation is present or intended. For example, in the claims below, when a claim element is described as having “one” feature, it is intended that the element be limited to one and only one of the feature described. Furthermore, when a claim element is described in the claims below as including or comprising “a” feature, it is not intended that the element be limited to one and only one of the feature described. Rather, for example, the claim including “a” feature reads upon an apparatus or method including one or more of the feature in question. That is, because the apparatus or method in question includes a feature, the claim reads on the apparatus or method regardless of whether the apparatus or method includes another such similar feature. This use of the word “a” as a nonlimiting, introductory article to a feature of a claim is adopted herein by Applicants as being identical to the interpretation adopted by many courts in the past, notwithstanding any anomalous or precedential case law to the contrary that may be found. Similarly, when a claim element is described in the claims below as including or comprising an aforementioned feature (e.g., “the” feature), it is intended that the element not be limited to one and only one of the feature described merely by the incidental use of the definite article.

Furthermore, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

While particular embodiments of the present invention have been shown and described, it will be obvious to those skilled in the art that, based upon the teachings herein, various modifications, alternative constructions, and equivalents may be used without departing from the invention claimed herein. Consequently, the appended claims encompass within their scope all such changes, modifications, etc. as are within the true spirit and scope of the invention. Furthermore, it is to be understood that the invention is solely defined by the appended claims. The above description is not intended to present an exhaustive list of embodiments of the invention. Unless expressly stated otherwise, each example presented herein is a nonlimiting or nonexclusive example, whether or not the terms nonlimiting, nonexclusive or similar terms are contemporaneously expressed with each example. Although an attempt has been made to outline some exemplary embodiments and exemplary variations thereto, other embodiments and/or variations are within the scope of the invention as defined in the claims below.

What is claimed is:

1. A remote monitoring system comprising:
a plurality of sensors configured to receive a signal from a transmitter, each of the sensors being configured to determine a signal strength of the signal responsive to receiving the signal; and
a console coupled to the plurality of sensors to receive the signal strength from each sensor which receives the signal, the console being configured to process the signal strength and information indicative of each sensor receiving the signal to determine a location related to the transmitter.

2. The system of claim 1 wherein the information indicative of each sensor includes location information for each sensor.

3. The system of claim 1 wherein the information indicative of the sensor includes sensor identity information which uniquely identifies each sensor, the console being configured to determine location information of each sensor responsive to receiving the sensor identity information for each sensor.

4. The system of claim 1 wherein
the transmitter is one of a plurality of transmitters; and
the console is further configured to process information which uniquely identifies the transmitter to determine an identity of the transmitter.

5. The system of claim 4 wherein the console further comprises:
a database for storing transmitter identity information.

6. The system of claim 5 wherein the database includes information which identifies an assigned possessor of the transmitter and which identifies any known medical conditions associated with the assigned possessor.

7. The system of claim 1 further comprising:
a collector coupled to the console via a serial coupling; and
a local area network coupling each of the sensors to the collector.

8. The system of claim 1 further comprising a wired network to which the sensors are coupled, the wired network capable of providing backup power to the sensors.

9. The system of claim 1 wherein each sensor is coupled to a backup DC power source configured to provide power if insufficient AC power for sensor operation is received by the sensor.

10. The system of claim 1 wherein each sensor comprises a double helical coil antenna for receiving transmissions from the transmitter.

11. The system of claim 10 wherein each sensor further comprises:
a super-heterodyne receiver unit coupled to the antenna, the receiver unit capable of performing pass band filtering to filter out noise signals; and
a processor circuit coupled to the receiver unit, the processor circuit being configured to determine the signal strength and to initiate transmission of the signal strength to the console.

12. The system of claim 1 further comprising the transmitter, wherein the transmitter comprises:
a signal activator; and
a wireless transmitter portion coupled to the signal activator to transmit information responsive to activation of the signal activator.

13. The system of claim 12 wherein the transmitter is configured to transmit information which identifies at least one of the transmitter, an assigned user of the transmitter, and an emergency type.

14. The system of claim 12 wherein the transmitter is configured to provide transmitter identity information which uniquely identifies the transmitter, said transmitter identity information being changeable over time while still uniquely identifying the transmitter.

15. The system of claim 12 wherein the wireless transmitter portion is configured to transmit on a single radio frequency.

16. The system of claim 12 wherein the wireless transmitter portion is configured to transmit error detection information.

17. The system of claim 16 wherein the error detection information comprises a rolling checksum.

18. The system of claim 12 wherein the wireless transmitter portion is configured to transmit error correction information.

19. The system of claim 12 wherein the transmitter is configured to periodically transmit a maintenance transmission so that the console can verify that the transmitter is operational.

20. The system of claim 12 wherein the signal activator comprises at least one depressible button.

21. The system of claim 12 wherein the transmitter includes an attachment portion, the attachment portion for attaching the transmitter to an assigned user.

22. The system of claim 1 wherein the wireless transmitter is one of a plurality of transmitters, each transmitter being configured to vary transmission times to avoid constant interference with other transmitter transmissions.

23. The system of claim 1 wherein the console comprises:
a general purpose information processing subsystem including a processor and associated memory; and
a remote monitor software control module accessible to the information processing subsystem, the software control module for configuring the information processing subsystem to process the signal strength and information indicative of each sensor receiving the signal to determine a location related to the transmitter.

24. The system of claim 23 wherein the console further comprises:
a database for storing sensor identity information and sensor location information.

25. The system of claim 23 wherein the console further comprises:
remote communication software for communicating with at least one of the group consisting of a remote console and a remote communications device.

26. The system of claim 25 wherein the remote communications device is one of the group consisting of a telephone, a facsimile machine, a pager, a cellular phone, a satellite phone, and an email-capable information processing system.

27. The system of claim 1 further comprising:
a video camera coupled to provide video data to the console.

28. A method comprising:
configuring a plurality of sensors to receiving a wireless signal from a transmitter and to providing transmission information by each sensor responsive to receiving the wireless signal, the transmission information defined to include at least two of a signal strength indication, transmitter identity information and sensor identity information; and
configuring a computer system to receive the transmission information from each sensor which receives the wireless signal and to determine a location of the transmitter using the transmission information.

29. The method of claim 28 further comprising:
receiving the wireless signal from the transmitter by at least one sensor of the monitor array;
determining a received signal strength indication regarding the wireless signal by each of the at least one sensor; and
providing the transmission information by each of the at least one sensor to the computer system.

30. The method of claim 29 further comprising:
receiving the transmission information from each of the at least one sensor; and
periodically automatically determining a new location of the transmitter sending the wireless signal.

31. The method of claim 28 further comprising:
receiving the transmission information from each sensor which receives the wireless signal; and
automatically determining a location of the transmitter sending the wireless signal.

32. The method of claim 31 further comprising:
automatically contacting emergency response personnel responsive to receiving the transmission information and determining the location.

33. The method of claim 32 further comprising:
providing location information regarding the location upon contacting the emergency response personnel.

34. The method of claim 33 further comprising:
automatically determining a new location of the transmitter sending the wireless signal responsive to receiving new transmission information.

35. The method of claim 34 further comprising:
automatically providing the new location information to the emergency response personnel.

36. In a system including a computer system and a plurality of sensors with known locations coupled to the computer system, a method comprising:
receiving a wireless signal by one or more sensors from a transmitter;
providing transmission information by each of the one or more sensors responsive to receiving the wireless signal, the transmission information including at least two of a signal strength indication, transmitter identity information and sensor identity information; and
determining a location of the transmitter by the computer system using the transmission information.

37. The method of claim 36 further comprising:
determining an initial signal strength indication indicative of noise signals when no transmitter is transmitting;
compensating a measured signal strength indication of the wireless signal with the initial signal strength indication to generate the signal strength indication.

38. The method of claim 36 further comprising:
determining that the transmission information is valid; and
contacting emergency response personnel by the computer system after determining the transmission information is valid.

39. The method of claim 38 wherein the emergency response personnel comprise one or more of law enforcement personnel and medical service provider personnel.

40. The method of claim 38 further comprising:
providing location information regarding the location of the transmitter upon contacting the emergency response personnel.

41. An apparatus comprising:
a plurality of sensors, each sensor including a means for receiving a wireless signal from a transmitter and means for providing transmission information including at least two of a signal strength indication, transmitter identity information and sensor identity information; and
a computer system coupled to each of the plurality of sensors, the computer system including means for determining a location of the transmitter using the transmission information.

42. The apparatus of claim 41 further comprising:
means for determining an initial signal strength indication indicative of noise signals when no transmitter is transmitting;
means for compensating a measured signal strength indication of the wireless signal with the initial signal strength indication to generate the signal strength indication.

43. The apparatus of claim 41 further comprising:
means for contacting emergency response personnel by the computer system responsive to receiving the transmission information and determining the location.

44. The apparatus of claim 41 further comprising:
means for providing location information regarding the location of the transmitter to emergency response personnel.
